(19) United States
(12) Patent Application Publication
(10) Pub. No.: US 2023/0111943 A1
(43) Pub. Date: Apr. 13, 2023

(54) COMMUNICATION APPARATUS, CONTROL METHOD, STORAGE MEDIUM, AND COMMUNICATION METHOD

(71) Applicant: CANON KABUSHIKI KAISHA, Tokyo (JP)

(72) Inventors: Yoichi Maeda, Kanagawa (JP); Kazuhiko Morimura, Kanagawa (JP)

(21) Appl. No.: 17/950,162

(22) Filed: Sep. 22, 2022

(30) Foreign Application Priority Data
Oct. 7, 2021 (JP) 2021-165651

(51) Int. Cl. H04L 41/12; H04L 41/0897

(52) U.S. Cl. CPC H04L 41/12; H04L 41/0897

(57) ABSTRACT

A communication apparatus that performs communication that uses Transmission Control Protocol (TCP) via one or more network slices determines a respective configuration of the one or more network slices based on a respective state of the communication that uses TCP in the one or more network slices and a respective required quality in the one or more network slices, and makes a request to an apparatus that manages the one or more network slices so as to perform the determined configuration.

### BACKGROUND OF THE INVENTION

### Field of the Invention

The present invention relates to a technique for controlling communication in a network slice.

### Description of the Related Art

The 3rd Generation Partnership Project (3GPP) defines performing communication using network slices obtained by virtually dividing a network for each service requirement. Japanese Patent Laid-Open No. 2020-092453 discloses a technique for allocating a network slice based on the quality of communication required by user equipment. In a network slice, it is possible to perform communication using Transmission Control Protocol/Internet Protocol (TCP/IP). Japanese Patent Laid-Open No. 2018-026711 describes a technique for managing the quality of communication in communication that uses TCP/IP by performing bandwidth control using statistical information.

The technique described in Japanese Patent Laid-Open No. 2018-026711 manages the quality of communication of the entire TCP/IP communication based on statistics of communication performed using TCP/IP and cannot handle situations where the appropriate quality of communication is different for each instance of TCP/IP communication. Therefore, appropriate communication control that is based on, for example, required qualities (bandwidth (throughput), delay, reliability, etc.) for each instance of communication cannot be performed.

### SUMMARY OF THE INVENTION

The present invention provides a technique for enabling an execution of appropriate communication control that is based on a required quality for each instance of communication.

According to one aspect of the present invention, there is provided a communication apparatus comprising: at least one memory that stores a set of instructions; and at least one processor that executes the instructions, the instructions, when executed, causing the communication apparatus to perform operations comprising: performing communication that uses Transmission Control Protocol (TCP) via one or more network slices; determining a respective configuration of the one or more network slices based on a respective state of the communication that uses TCP in the one or more network slices and a respective required quality in the one or more network slices; and making a request to an apparatus that manages the one or more network slices so as to perform the determined configuration.

According to another aspect of the present invention, there is provided a communication method for a communication apparatus, the communication method comprising: in a case of performing data communication by using a first protocol in the communication apparatus, making a request to an orchestrator to allocate a first network slice for communication that uses the first protocol based on characteristics of data communication that uses the first protocol; and in a case of performing data communication by using a second protocol in the communication apparatus, making a request to the orchestrator to allocate a second network slice for communication that uses the second protocol based on characteristics of data communication that uses the second protocol, wherein in a state in which the first network slice and the second network slice have been allocated, (1) in a case where the communication apparatus performs data transmission by using the first protocol, data transmission that is directed to the first network slice is performed, and (2) in a case where the communication apparatus performs data transmission by using the second protocol, data transmission that is directed to the second network slice is performed.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of a communication system.

FIG. 2 is a diagram illustrating an example of a hardware configuration of an apparatus.

FIG. 3 is a diagram illustrating an example of a flow of communication control executed in the communication system.

FIG. 4 is a diagram illustrating an example of a socket table.

FIG. 5 is a diagram illustrating a state machine in TCP.

FIG. 6 is a diagram illustrating a bandwidth-delay product.

FIG. 7 is a diagram illustrating an example of well-known ports.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

(System Configuration)

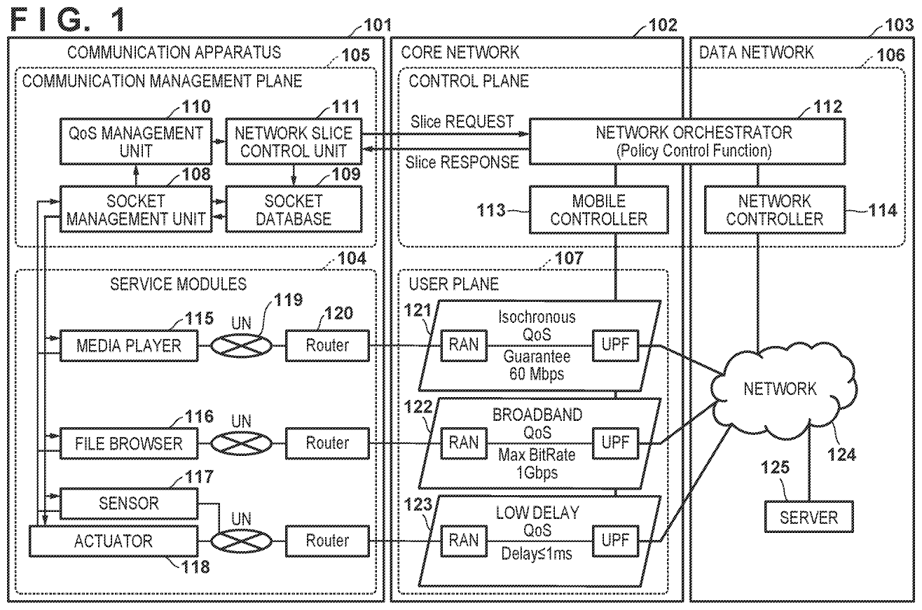

FIG. 1 illustrates an example of a configuration of a communication system according to the present embodiment. The communication system is configured to include, for example, a communication apparatus 101, a core network 102, and a data network 103. The core network 102 is, for example, a long-term evolution (LTE) or fifth-generation (5G) cellular communication system network and is configured to include a radio access network (RAN). The core network includes a control plane 106 and a user plane 107. The communication apparatus 101 is configured to be capable of establishing a wireless connection with an RAN of the core network 102 to perform wireless communication. The core network 102 can connect the communication apparatus 101, which is a terminal apparatus of a cellular communication system, and the data network 103, which is external to the network of the cellular communication system, via a user plane function (UPF). The communication apparatus 101 is configured to be capable of accessing the data network 103 via the core network 102 and obtain information from the data network 103 as well as transmit information to the data network 103.

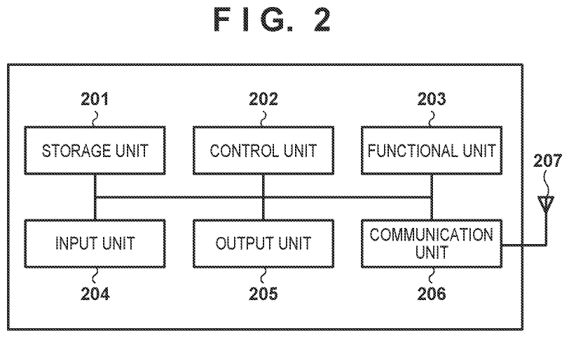

The core network 102 and the data network 103 are configured to include a computer such as one or more servers that include a plurality of communication functions. These apparatuses and the communication apparatus 101 may include functions of a typical computer as illustrated in, for example, FIG. 2. That is, each apparatus includes, as an example of its hardware components, a storage unit 201, a control unit 202, a functional unit 203, an input unit 204, the output unit 205, and a communication unit 206. Also, for example, the communication apparatus 101 and RAN nodes in the core network 102 include an antenna 207 for wireless communication.

The storage unit 201 is configured by one or more memories that include both or either one of a ROM and a RAM and the storage unit 201 stores various kinds of information, such as programs for performing various operations, which will be described later, and parameters for communication. ROM is an acronym for Read Only Memory, and RAM is an acronym for Random Access Memory. In addition to memories, such as a ROM and a RAM, a storage medium, such as a flexible disk, a hard disk, an optical disk, a magneto-optical disk, a CD-ROM, a CD-R, a magnetic tape, a non-volatile memory card, or a DVD, may be used as the storage unit 201. The storage unit 201 may also be configured to include storage apparatuses such as a plurality of memories.

The control unit 202 is configured by, for example, one or more processors, such as a CPU and an MPU; an application-specific integrated circuit (ASIC); a digital signal processor (DSP); a field-programmable gate array (FPGA); and the like. CPU is an acronym for Central Processing Unit, and MPU is an acronym for Micro Processing Unit. The control unit 202 may be a multi-core processor. The control unit 202 controls the entire apparatus by executing a program stored in the storage unit 201. A configuration may be taken such that the control unit 202 controls the entire apparatus by cooperating with programs and an Operating System (OS) stored in the storage unit 201.

Further, the control unit 202 controls the functional unit 203 to execute predetermined processing. The functional unit 203 is hardware for the apparatus to execute predetermined processing. The communication apparatus 101 includes, for example, an image capturing function or a printing function and may include a camera or a printer as the functional unit 203. The data to be processed by the functional unit 203 may be data that is stored in the storage unit 201 or may be data that has been communicated from another apparatus via the communication unit 206, which will be described later. The functional unit 203 may also include a processing circuit for maintaining and managing the functions of the above-described core network 102 and the data network 103.

The input unit 204 performs reception of various operations from a user. The output unit 205 performs various outputs to the user. Here, the outputs by the output unit 205 include, for example, at least one of a display on a screen, audio output by a speaker, vibration output, and the like. A configuration may be taken so as to realize both the input unit 204 and the output unit 205 by one module as in the case of a touch panel.

The communication unit 206 is configured to include a communication circuit for controlling wired communication or wireless communication and controlling TCP/IP communication. The communication unit 206 may also control the antenna 207 to transmit and receive radio signals for wireless communication. An AP and an STA communicate content, such as image data, document data, and video data, with another communication apparatus via the communication unit 206. The antenna 207 is, for example, an antenna that is capable of transmitting and receiving radio signals in a frequency band that has been defined in a cellular communication system.

Returning to FIG. 1, a functional configuration of the communication apparatus 101 will be described. The communication apparatus 101 includes, as its functional components, service modules 104, which provide communication services to the user via the UPF. The service modules 104 include, for example, a media player 115, a file browser 116, a sensor 117, and an actuator 118. These service modules 104 are incorporated into the communication apparatus 101, and the communication apparatus 101 may obtain data from the data network 103 via these modules. The modules may be connected to the core network 102 via a user network (a UN 119) and a router 120 and further connected to the data network 103.

The communication apparatus 101 further includes, as a function, a communication management plane 105. The communication management plane 105 is configured to include a socket management unit 108, a socket database 109, a QoS management unit 110, and a network slice control unit 111. The socket management unit 108 manages, for example, Transmission Control Protocol/Internet Protocol (TCP/IP) socket communication by the service modules 104. The socket database 109 stores TCP/IP socket information in the form of, for example, a socket table, which will be described later, and provides that information to, for example, the socket management unit 108. The QoS management unit 110 controls and manages the quality of communication (Quality of Service (QoS)) in the communication apparatus 101. The network slice control unit 111 performs control for communication that uses network slices by making a request for a network slice to the core network 102 in accordance with a request from the QoS management unit 110 and receiving a response.

The core network 102 includes the control plane 106 and the user plane 107 as described above. The control plane 106 performs connection control and session management control, and the user plane 107 communicates user data. The core network 102 includes functions that are not illustrated in FIG. 1, such as an authentication server, a session management apparatus, and an application server. The control plane 106 is configured to include a network orchestrator 112 and a mobile controller 113. The network orchestrator 112 performs management, control, and the like of network slices for various services. The mobile controller 113 configures network slices suitable for the respective services under the control of the network orchestrator 112. The mobile controller 113 may configure network slices such that, for example, a predetermined throughput can be guaranteed for high-speed transmission or such that it is possible to perform reliable communication whose error rate, such as a frame error rate, is extremely low. The control plane 106 may further, if necessary, control the data network 103 side using a network controller 114. The user plane 107 may define a plurality of virtual network slices 121 to 123 allocated by the mobile controller 113. Each network slice is allocated a radio access network (RAN) for wireless communication with the communication apparatus 101 and a user plane function (UPF) for communicating with the data network.

The data network 103 includes a network 124, such as the Internet or a Wide Area Network (WAN), such as an intranet. Some networks include a network controller 114 such as an Open Flow controller. The network controller 114 receives a network policy required by the network orchestrator 112 and realizes a priority communication service by managing a QoS in cooperation with the core network 102. For example, in the example of FIG. 1, the media player 115 is provided with a first network slice that guarantees a 60-Mbps throughput. The file browser 116 is allocated a second network slice whose maximum throughput is 1 Gbps, although it is not guaranteed. Also, the sensor 117 and the actuator 118 are allocated a low-delay third network slice. For example, since the sensor 117 and the actuator 118 have a characteristic of frequently transmitting and receiving data of a small amount, the third network slice does not require a guaranteed throughput.

The present embodiment provides a mechanism for managing the quality of communication in a communication system that uses TCP/IP by allocating an appropriate bandwidth to each network slice. That is, TCP/IP is conventionally capable of best-effort communication, and it is not easy to perform priority control for communication that accords with requirements such as throughput, delay amount, and error qualities. In contrast, the present embodiment makes it possible to execute priority control for configuring an appropriate bandwidth and delay amount based on throughput, delay, reliability, and the like in accordance with the content of communication. This makes it possible to perform appropriate communication control, for example, for each network slice, in a network that uses TCP/IP.

(Processing Flow)

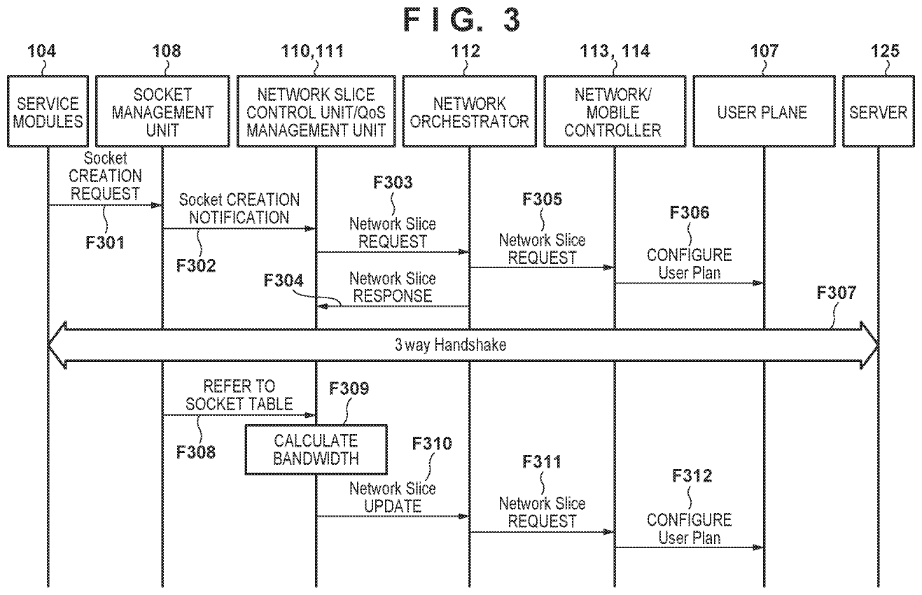

A flow of communication processing according to the present embodiment will be described with reference to FIG. 3. The communication apparatus 101 generates a socket table in an internal storage area of the communication apparatus 101 prior to initiating communication. For example, when a service module 104 detects that communication should be started by, for example, a user operation, it notifies the socket management unit 108 of a request to create a socket table required for communication (F301). Then, the socket management unit 108 creates a socket table according to the notification.

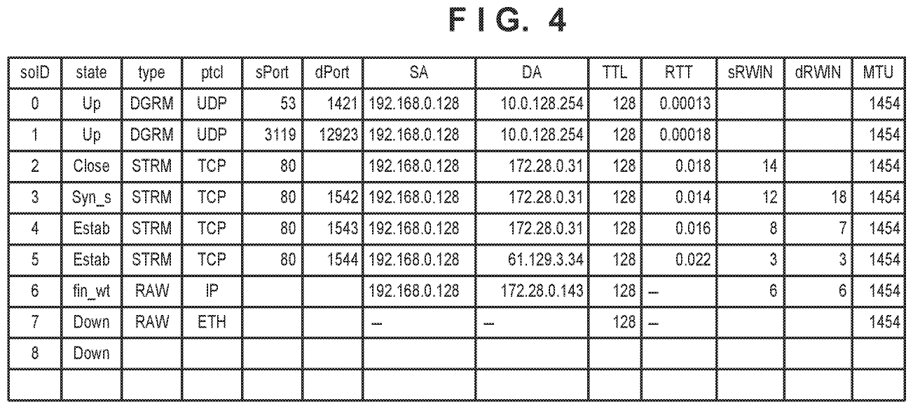

An example of a socket table to be generated will be described with reference to FIG. 4. FIG. 4 illustrates an example of a socket table to be generated. In the socket table, for example, a unique identifier called a socket ID (soID) for uniquely identifying socket communication that has been performed is allocated and held. The socket table includes a source address (SA) and a destination address (DA) of the socket in the communication that corresponds to each socket ID. In addition, it includes a source port (sPort) and a destination port (dPort) for each socket ID. Four pieces of information, an SA, a DA, an sPort, and a dPort, are called a socket pair.

The socket table further includes a source receive window (sRWIN) and a destination receive window (dRWIN). The “receive window (RWIN)” indicates a receive buffer size. In TCP/IP, a receive buffer is provided at both the source and destination in response to the connection being fully established, which is called ESTABLISH, and transmission and reception becoming possible. In addition, the socket table includes a round trip time (RTT). A measured value of a round-trip time of communication is recorded as the RTT. In addition, the socket table includes a communication state (state), a type of communication (type), a protocol (ptcl), Time To Live (TTL), and Maximum Transmission Unit (MTU). While executing communication, the socket management unit 108 registers the above-described elements of that communication in the socket table.

Returning to FIG. 3, the socket management unit 108 notifies the QoS management unit 110 and the network slice control unit 111 of the creation of a socket (F302). When the network slice control unit 111 detects the creation of a socket, it notifies the network orchestrator 112 of the core network 102 of a slice creation request in order to prepare a network slice for connecting the source and the destination (F303). Then, the network orchestrator 112 transmits a response to the network slice control unit 111 to notify it of the preparation for creating a network slice (F304). The network orchestrator 112 instructs the mobile controller 113 and the network controller 114 to create a network slice (F305). Based on this instruction, the mobile controller 113 and the network controller 114 create a network slice on the user plane 107 (F306). When the service module 104 is notified of Accept from the socket management unit 108, it executes a 3wayHandshake to initiate data communication with a server 125 (F307).

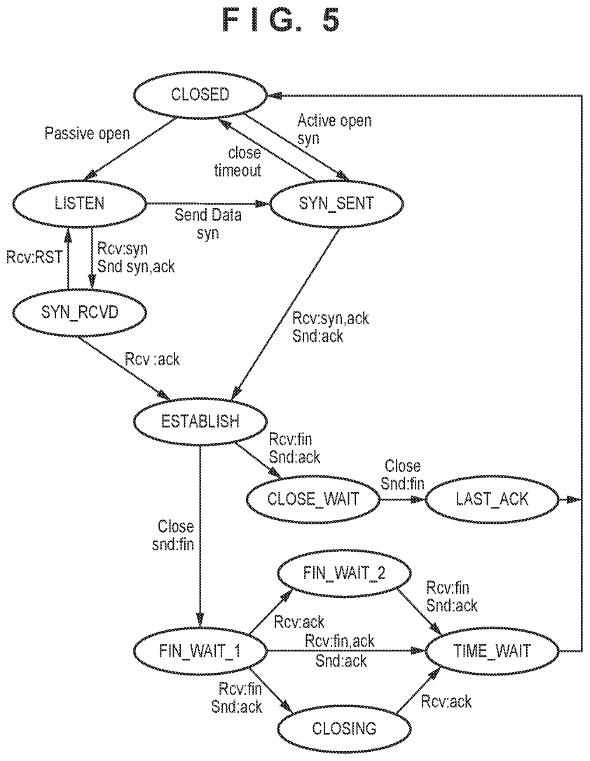

FIG. 5 illustrates a TCP state machine. When a TCP socket is created, the state is CLOSED, and in this state, communication that includes data cannot be started. When a 3wayHandshake is started, a Syn packet is transmitted from a source address to a destination address and, accordingly, a Syn, ack packet is transmitted from the destination address to the source address confirming the arrival of the Syn packet. When the source address transmits an ack packet notifying the destination address of reception of the Syn, ack packet, the state transitions to ESTABLISH. The confirmation of information at the time of a 3wayHandshake activates the destination server, prepares the receive window, measures an RTT that includes a round-trip propagation delay required for a packet and a processing time, and thus, a network slice for data communication is prepared.

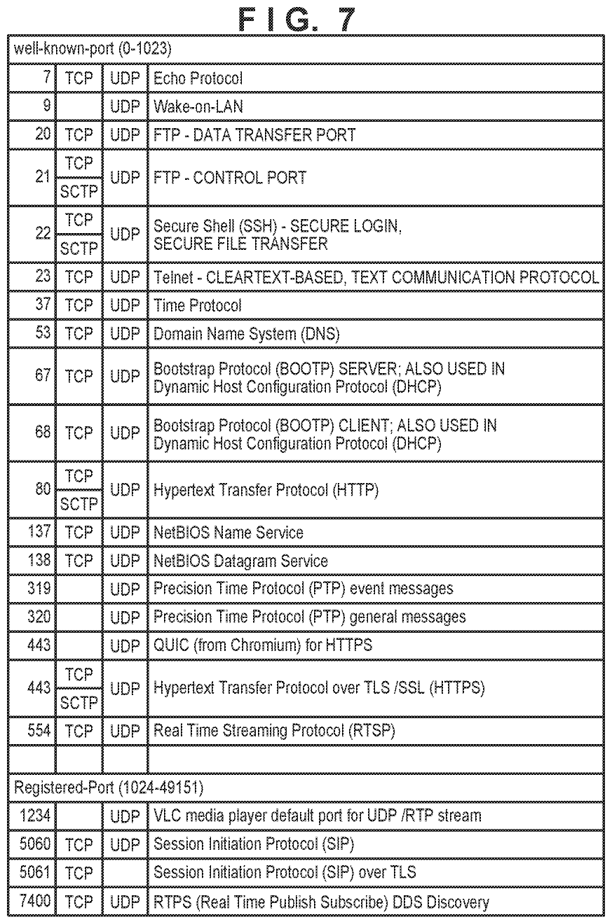

After data communication is started, the network slice control unit 111 refers to the information of the socket table via the socket management unit 108 (F308) and determines a bandwidth to be configured for the network slice (F309). In one example, the network slice control unit 111 may estimate the type of communication by referring to a socket pair (i.e., an SA, a DA, an sPort, and a dPort) from the socket table of FIG. 4. For example, the type of communication is estimated in accordance with the communication port based on a relationship between a communication port and a protocol to be used, such as FIG. 7. That is, when the port number of a port included in the socket pair for the communication to be performed matches the port number of a so-called well-known port as illustrated in FIG. 7, the protocol of that communication can be identified as a protocol corresponding to that well-known port. Then, by identifying a receive window size and an RTT that are used in that protocol, it is possible to specify a bandwidth to be secured for that communication. The communication protocol need not be identified by the port; for example, the service module 104 may explicitly notify the network slice control unit 111 of the communication protocol to be used.

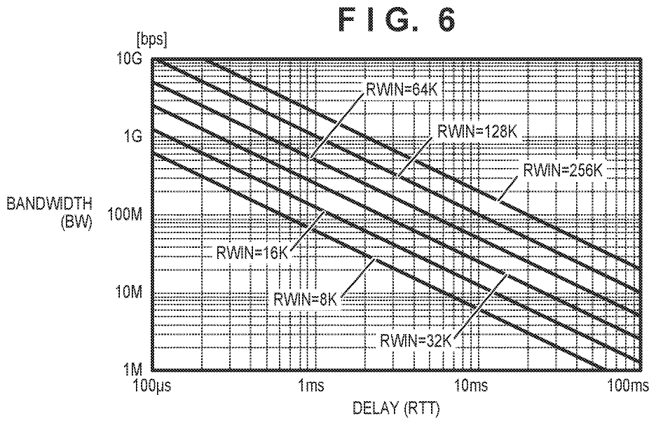

For example, the first network slice is connected to the media player 115, and the Real Time Streaming Protocol (RTSP) may be used as the protocol. In this case, the network slice control unit 111 can estimate a bandwidth to be allocated to a network slice by identifying a receive window size and an RTT used in RTSP. The network slice control unit 111 may specify, for example, a bandwidth to be configured for a network slice based on a bandwidth-delay product as illustrated in FIG. 6. In TCP/IP, a bandwidth at which transmission can be performed is limited by a bandwidth-delay product regardless of the bandwidth of a provided transmission line. In FIG. 6, the horizontal axis represents an RTT (delay time), and the vertical axis represents a bandwidth that can be used for communication. When each receive window size (RWIN) is determined and an RTT is measured, a bit rate at which communication can be performed is determined. For example, if the RWIN is 64 KByte and the RTT is 1 msec, a 524-Mbps bandwidth can be used. For this reason, for example, even if a 1-Gbps bandwidth is provided or even if more bandwidth than 524 Mbps is allocated to the network slice, it is assumed that it cannot be effectively utilized. Therefore, the network slice control unit 111 may make it so as not to allocate more than a 524-Mbps bandwidth for such communication. In this way, the network slice control unit 111 can specify a usable bandwidth by calculating a bandwidth-delay product based on a receive window size and an RTT described in the socket table. A table that indicates the correspondence between a receive window size and an RTT and corresponds to a bandwidth-delay product may be prepared, and the network slice control unit 111 may specify, a bandwidth by referring to that table. Further, RWIN may be the smaller of the receive window size and the congestion window size. That is, a bandwidth may be specified based on the congestion window size and the RTT.

The network slice control unit 111 may establish a best-effort connection whose throughput is not guaranteed for the file browser 116 allocated as a second service module. In this case, a network slice whose maximum bandwidth is 1 Gbps and throughput is not guaranteed and in which delay is also acceptable may be used. The network slice control unit Ill may establish a low-delay connection for the sensor 117 and the actuator 118. Here, the network slice control unit 111 may determine to, for example, determine bandwidths for other network slices, such as a bandwidth for a low-delay network slice, and then allocate the remaining bandwidth to a network slice whose throughput is not guaranteed.

After specifying a bandwidth, the network slice control unit 111 makes a request to the network orchestrator 112 in the core network 102 to update the configuration of the slice for which a creation request has been made in F303 (F310). The network orchestrator 112 transmits (F311) an instruction to the mobile controller 113 and the network controller 114 to update the configuration in response to that request. The mobile controller 113 and the network controller 114 update bandwidth configuration information of the network slice based on that instruction (F312).

The network slice control unit 111 may continue to, for example, measure the RTT, monitor the RWIN, and the like; adaptively change the allocation of a bandwidth; and make a request to the network orchestrator 112 to update the configuration of that slice. This makes it possible to perform communication control so as to be able to sufficiently satisfy a required communication quality in response to a change in the communication state. In the above description, an example has been described in which the communication apparatus 101 determines a bandwidth to be allocated to each of a plurality of network slices based on information (socket table) on the respective network slices that indicates a state of communication that uses TCP. However, this is only one example, and similar processing can be performed on only one network slice. Further, in the above-described example, a configuration for determining a bandwidth to be allocated to a network slice has been described, but the present invention is not limited to this. That is, in addition to or as an alternative to the above-described configuration, the communication apparatus 101 may make a request to the network orchestrator 112 to control other parameters of the network slice. For example, the communication apparatus 101 may make a request for changing the configuration so as to shorten delay to the network orchestrator 112 so that the RTT becomes shorter than a predetermined value in the above-described third network slice. Further, the communication apparatus 101 may make a request for changing the configuration for error control to the network orchestrator 112 so that the error rate takes on a value that is suitable for the communication service.

As described above, in the present embodiment, the communication apparatus 101 holds the state of communication by TCP as a socket table (database) and, based on that socket table, performs bandwidth control of a network slice. This makes it possible to, when performing communication that uses TCP in a network slice, guarantee a required quality for that network slice.

According to the present invention, it becomes possible to perform appropriate communication control that is based on a required quality for each instance of communication.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-165651, filed Oct. 7, 2021, which is hereby incorporated by reference herein in its entirety.

What is claimed is:

1. A communication apparatus comprising:
at least one memory that stores a set of instructions; and
at least one processor that executes the instructions, the instructions, when executed, causing the communication apparatus to perform operations comprising:
performing communication that uses Transmission Control Protocol (TCP) via one or more network slices;
determining a respective configuration of the one or more network slices based on a respective state of the communication that uses TCP in the one or more network slices and a respective required quality in the one or more network slices; and
making a request to an apparatus that manages the one or more network slices so as to perform the determined configuration.

2. A control method to be executed by a communication apparatus that performs communication that uses Transmission Control Protocol (TCP) via one or more network slices, the control method comprising:
determining a respective configuration of the one or more network slices based on a respective state of the communication that uses TCP in the one or more network slices and a respective required quality in the one or more network slices; and
making a request to an apparatus that manages the one or more network slices so as to perform the determined configuration.

3. The control method according to claim 2, w % herein, in the determining, a bandwidth to be used in at least one of the one or more network slices is determined, and
the request is a request for configuring such that communication is performed in the bandwidth for the at least one of the one or more network slices.

4. The control method according to claim 3, wherein the bandwidth is determined based on a round trip time of the communication that uses the TCP and a receive window size or a congestion window size.

5. The control method according to claim 2, further comprising:
managing the respective state of the communication that uses the TCP in the one or more network slices.

6. The control method according to claim 2, wherein the apparatus that manages the one or more network slices is an orchestrator.

7. A non-transitory computer-readable storage medium that stores a program for causing a computer included in a communication apparatus to:
perform communication that uses Transmission Control Protocol (TCP) via one or more network slices;
determining a respective configuration of the one or more network slices based on a respective state of the communication that uses TCP in the one or more network slices and a respective required quality in the one or more network slices; and
making a request to an apparatus that manages the one or more network slices so as to perform the determined configuration.

8. A communication method for a communication apparatus, the communication method comprising:
in a case of performing data communication by using a first protocol in the communication apparatus, making a request to an orchestrator to allocate a first network slice for communication that uses the first protocol based on characteristics of data communication that uses the first protocol; and
in a case of performing data communication by using a second protocol in the communication apparatus, making a request to the orchestrator to allocate a second network slice for communication that uses the second protocol based on characteristics of data communication that uses the second protocol,
wherein in a state in which the first network slice and the second network slice have been allocated,
(1) in a case where the communication apparatus performs data transmission by using the first protocol, data transmission that is directed to the first network slice is performed, and
(2) in a case where the communication apparatus performs data transmission by using the second protocol, data transmission that is directed to the second network slice is performed.
